(19) United States
(12) Patent Application Publication
(10) Pub. No.: US 2015/0177792 A1
(43) Pub. Date: Jun. 25, 2015

(54) ELECTRONIC DEVICE

(71) Applicant: Kabushiki Kaisha Toshiba, Tokyo (JP)

(72) Inventors: Lin Vic, Taipei (TW); Chiu Brad, Taipei (TW); Chen Patrick, Taipei (TW); Huang San, Taipei (TW); Wu Tommy, Taipei (TW); Minoru Enomoto, Higashiyamato Tokyo (JP)

(21) Appl. No.: 14/484,587

(22) Filed: Sep. 12, 2014

Related U.S. Application Data
(60) Provisional application No. 61/919,467, filed on Dec. 20, 2013.

(51) Int. Cl. G06F 1/16

(52) U.S. Cl. CPC G06F 1/1679; G06F 1/1635; G06F 1/1605; G06F 1/1669

(57) ABSTRACT

According to one embodiment, an electronic device includes a device body which includes a main system unit and an option unit detachably connected to the main system unit. The main system unit includes a first housing including a first connection side surface and a first engagement portion at the first connection side surface, and a main control circuit board in the first housing. The option unit includes a second housing including a second connection side surface opposing to the first connection side surface of the first housing and a second engagement portion at the second connection side surface, an option device at the second housing, and a lock mechanism configured to lock the second housing, and a release member configured to release from locking.

### CROSS-REFERENCE TO RELATED APPLICATIONS

This application claims the benefit of U.S. Provisional Application No. 61/919,467, filed Dec. 20, 2013, the entire contents of which are incorporated herein by reference.

### FIELD

Embodiments described herein relate generally to an electronic device.

### BACKGROUND

As an electronic device, for example, a notebook personal computer (PC) comprises a flat device body and a display unit rotatably supported by the device body. A keyboard is provided on an upper surface of the device body. A control circuit board, a battery, etc. are provided in the device body.

Such a PC is used, with the device body placed on, e.g., a desk, and the display unit located upright. Also, PCs have been proposed in which display units are located to be laid over keyboards, and which can be used as tablet PCs. In recent years, it has been hoped to propose electronic devices which can be used in more various manners.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view of a notebook-sized portable computer provided as an electronic device according to a first embodiment;

FIG. 2 is an exploded perspective view of the portable computer in the case where an option unit is detached from the portable computer;

FIG. 3 is a plan view of the device body;

FIG. 4 is a plan view of an internal structure of the option unit in the case where the option unit is in the above detached state, which is viewed from a lower surface side of the option unit;

FIG. 5 is a plan view of the internal structure of the option unit in the case where the option unit is connected to a main system unit, which is viewed from the lower surface side of the option unit;

FIG. 6 is a perspective schematic view of a release lever (release knob) and a release latch portion of a lock mechanism of the option unit;

FIG. 7 is a perspective view of the internal structure of the option unit in the case where the option unit is detached from the main system unit, which is obtained as viewed from a lower side;

FIG. 8 is a perspective view of the internal structure of the option unit in the case where the option unit is connected to the main system unit, which is viewed from the lower side;

FIG. 9 is an exploded perspective view of another usage manner of the portable computer;

FIG. 10 is an exploded perspective view of still another usage manner of the portable computer;

FIG. 11 is a perspective view of a further usage manner of the portable computer;

FIG. 12 is a perspective view of a portable computer according to a second embodiment;

FIG. 13 is a perspective view of a portable computer according to a third embodiment;

FIG. 14 is a perspective view of a portable computer according to a fourth embodiment;

FIG. 15 is a perspective view of a portable computer according to a fifth embodiment;

FIG. 16 is a perspective view of a portable computer according to a sixth embodiment; and

FIG. 17 is a perspective view of a portable computer according to a seventh embodiment.

### DETAILED DESCRIPTION

Various embodiments will be described hereinafter with reference to the accompanying drawings. In general, according to one embodiment, an electronic device comprises a device body which comprises a main system unit and an option unit detachably connected to the main system unit. The main system unit comprises a first housing including a first main surface, a second main surface opposing to the first mine surface, a first connection side surface, and a first engagement portion provided at the first connection side surface; and a main control circuit board in the first housing. The option unit comprises a second housing including a first main surface continuous with the first main surface of the first housing, a second main surface continuous with the second main surface of the first housing, a second connection side surface configured to oppose to the first connection side surface of the first housing, and the second engagement portion provided at the second connection side surface and configured to detachably engage with the first engagement portion; an option device in the second housing; a lock mechanism provided at the second housing, and configured to lock the second housing, with the second housing connected to the first housing; and a release member configured to release from locking of the lock mechanism.

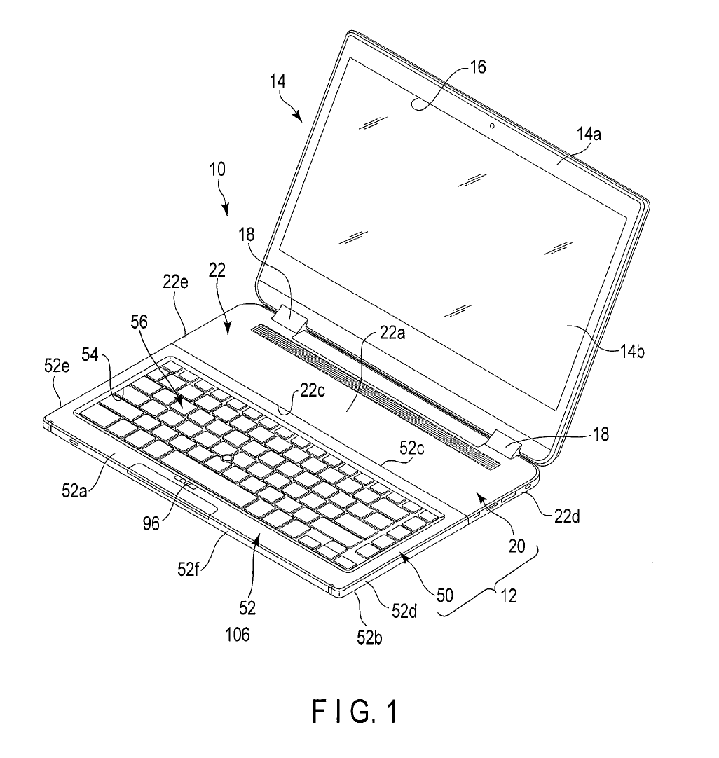

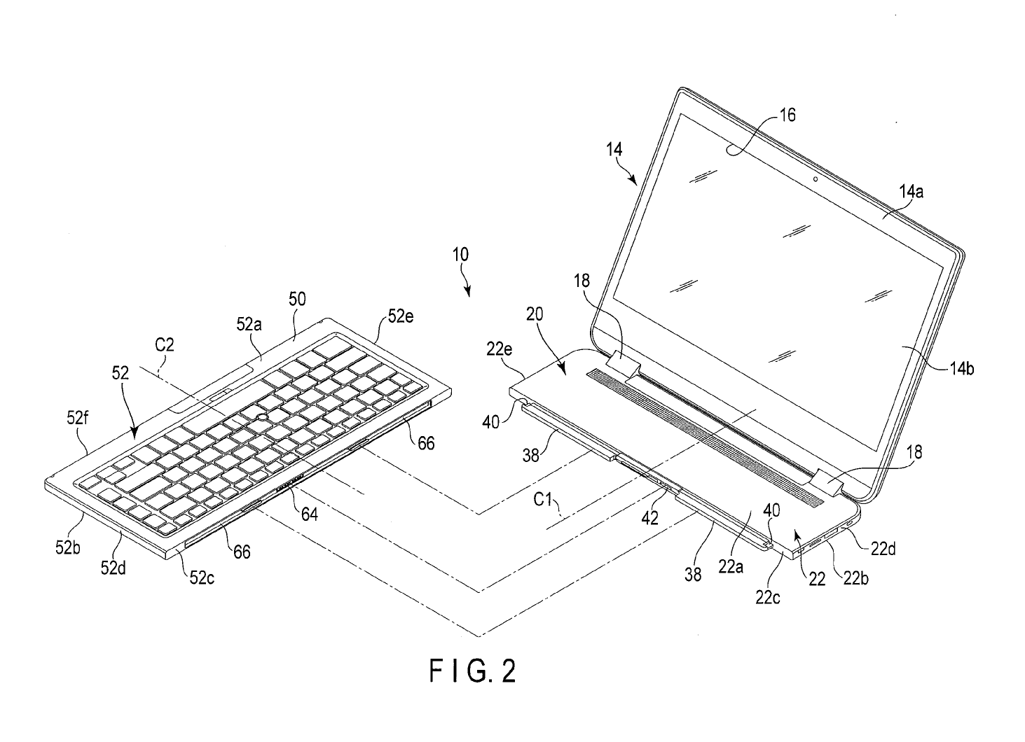

FIG. 1 is a perspective view of a notebook-sized portable computer 10 provided as an electronic device according to a first embodiment. FIG. 2 is an exploded perspective view of the portable computer in the case where an option unit is detached therefrom.

As shown in FIGS. 1 and 2, the portable computer 10 comprises a device body 12 having a flat and rectangular shape, and a display unit 14 supported by the device body 12 and having a flat and rectangular shape. The device body 12 comprises a main system unit 20 and an option unit 50 detachably connected to the main system unit 20.

The display unit 14 comprises a housing 14a having a flat and rectangular shape and a liquid crystal display panel 14b provided in the housing 14a. The liquid crystal display panel 14b includes a display surface exposed to a display window 16 formed in the housing 14a. As the liquid crystal display panel 14b, a so-called tablet-type of display panel having touch sensors may be applied.

The display unit 14 includes a pair of leg portions 18, which are rotatably supported by hinges at rear end portions of the main system unit 20. Thereby, the display unit 14 is rotatable between a closed position where it covers an upper surface of the device body 12 and an open (upright) position where it makes the upper surface of the device body 12 exposed as shown in FIG. 1. Also, the display unit 14 may be formed further rotatable from the open position as shown in FIG. 1 to a reverse position where it is laid over a reverse surface of the device body 12.

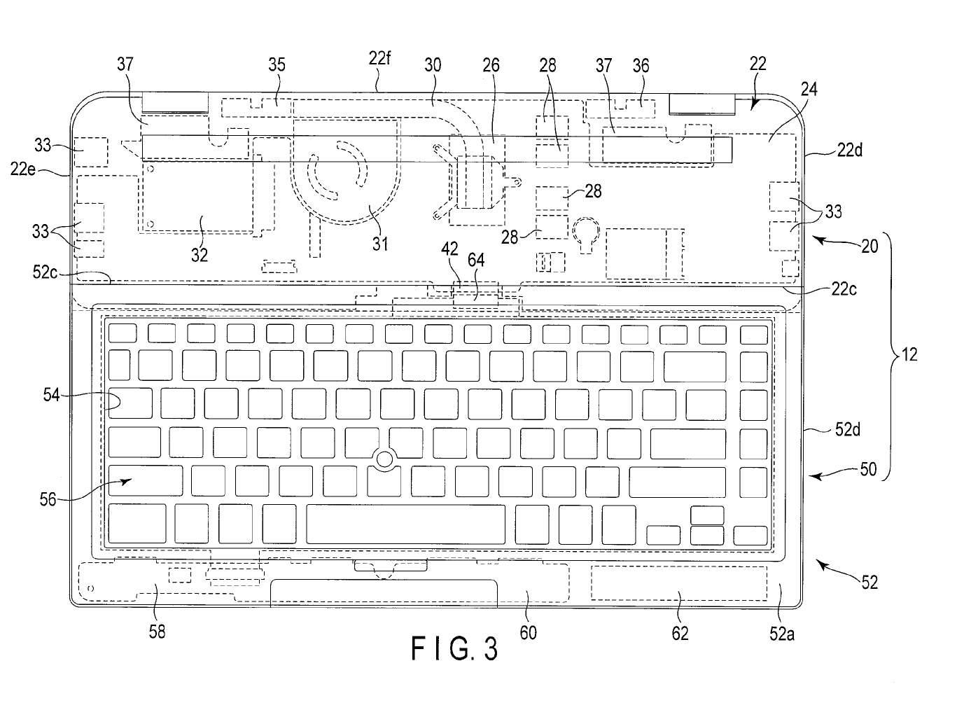

FIG. 3 is a plan view of the device body 12. As shown in FIGS. 1 to 3, the main system unit 20, which constitutes part of the device body 12, comprises a first housing 22 having an elongate and rectangular shape. The first housing 22 includes a rectangular upper surface (first main surface) 22a, a rectangular lower surface (second main surface) 22b, a first connection side surface 22c extending along one of its long sides, both side surfaces 22d and 22e extending along its short sides, respectively, and a rear-end side surface 22f extending along the other long side and located opposite to the first connection side surface 22c.

The main system unit 20 comprises a main control circuit board 24 having an elongate and rectangular shape and provided in the first housing 22, a plurality of semiconductor elements 28 including a CPU 26, mounted on the main control circuit board 24, a cooling unit including a cooling fan 31 and a heat pipe 30 which are configured to cool the CPU 26, a storage device, e.g., a solid-state drive (SSD) 32, various kinds of connectors 33 such as a USB connector, an HDMI output connector, an HP/Mic connector, a micro SD slot, and a DC-IN connector. Also, in the first housing 22, various devices are provided, such as a power supply board, a network module (Bluetooth module) for wireless communication) (a Wi-Fi main chip 35 and a Wi-Fi AUX chip antenna 36) a pair of speakers 37, etc.

As shown in FIGS. 2 and 3, the first housing 22 includes first engagement portions for connection with the option unit 50. For example, the first engagement portions include a pair of engagement ribs 38 having an elongate and rectangular shape and projecting from the first connection side surface 22c of the first housing 22 toward the option unit 50. The engagement ribs 38 extend in a longitudinal direction of the first connection side surface 22c and are arranged apart from each other. Engagement concave portions 40 are formed at side ends of the engagement ribs 38, respectively, which are opposite sides of facing sides of the engagement ribs 38 in the longitudinal direction, and which are located close to the side surfaces 22d and 22e of the first housing 22. With the engagement concave portions 40, clamp hooks of a lock mechanism 70 are engaged, which will be described later.

The engagement ribs 38 are formed to have a sufficient length and sufficiently project in order that connection of the option unit 50 be achieved without rattling. Furthermore, the pair of engagement ribs 38 and the pair of engagement concave portions 40 are formed symmetrically with respect to a center line C1 extending in a width direction of the first housing 22.

The main system unit 20 includes a power supply connector 42 connected to the main control circuit board 24. The power supply connector 42 is exposed at the first connection side surface 22c of the first housing 22, and located between the pair of the engagement ribs 38.

At the rear-end side surface 22f of the first housing 22, a pair of concave portions 44 are formed, and at the concave portions 44, the pair of leg portions 18 of the display unit 14 are located. The pair of leg portions 18 are supported by hinges provided in the first housing 22 and the display unit 14 in such a manner as to be rotatable with respect to the first housing 22.

In the embodiment, the option unit 50 is provided as a keyboard unit. To be more specific, as shown in FIGS. 1 to 3, the option unit 50 includes a second housing 52 having an elongate and rectangular shape. The second housing 52 includes a rectangular upper surface (first main surface) 52a, a rectangular lower surface (second main surface) 52b, a second connection side surface 52c extending along one of its long sides, both side surfaces 52d and 52e extending along its short sides, respectively, and a front-end side surface 52f extending along the other long side and located opposite to the second connection side surface 52c.

The second housing 52 is formed to have a width (a length in its longitudinal direction) and a thickness which are substantially equal to those of the first housing 22. That is, the second connection side surface 52c of the second housing 52 is formed to have substantially the same size as that of the first connection side surface 22c of the first housing 22. Also, when the second housing 52 is connected to the first housing 22, the second connection side surface 52c of the second housing 52 faces and tightly contacts the first connection side surface 22c of the first housing 22. Furthermore, the upper surface 52a and the lower surface 52b of the second housing 52 are located continuous and flush with the upper surface 22a and the lower surface 22b of the first housing 22, respectively. Similarly, the both side surfaces 52d and 52e of the second housing 52 are located continuous and flush with both the side surfaces 22d and 22e of the first housing 22.

Both side edge portions of the side surfaces 52d and 52e of the second housing 52 are rounded to have substantially the same curvature, which is also substantially the same as those of side edge portions of the first housing 22. By virtue of this feature, even when the second housing 52 is connected to the first housing 22, with the upper surface 52a and the lower surface 52b reversed, the lower and upper surfaces and both side surfaces of the second housing 52 are located continuous and flush with the upper and lower surfaces and both side surfaces of the first housing 22.

In the upper surface 52a of the second housing 52, a rectangular opening 54 is formed. As an option device, a keyboard 56 is provided in the second housing 52. Keys of the keyboard 56 are exposed in the opening 54. Furthermore, as shown in FIG. 3, in the second housing 52, a control circuit board 58, a wireless communication board (Bluetooth module) 60, a battery 62, a power supply connector 64, etc. are provided, the wireless communication board 60 being configured to send a key input signal to the main system unit 20, the battery 62 being provided to supply power to the control circuit board 58 and the wireless communication board 60, the power supply connector 64 being used in charging the battery 62. The power supply connector 64 is exposed at a substantially central portion of the second connection side surface 52c which is substantially center in a longitudinal direction thereof. The power supply connector 64 is connected to the power supply connector 42 of the main system unit 20, when the option unit 50 is connected to the main system unit 20.

As shown in FIGS. 2 and 3, the second connection side surface 52c of the second housing 52 includes second engagement portions, e.g., a pair of engagement grooves (or a continuous stretch of engagement groove) 66 with which the engagement ribs 38 of the first housing 22 are to be engaged. The engagement grooves 66 extend in a longitudinal direction of the second connection side surface 52c, and located apart from each other. The engagement grooves 66 are formed to have such lengths, depths and widths as to correspond to the engagement ribs 38. Also, the engagement grooves 66 are formed symmetrically with respect to a center line C2 extending in a width direction of the second housing 52. The power supply connector 64 is exposed at the second connection side surface 52c of the second housing 52, and located between the engagement grooves 66.

As shown in FIGS. 1 to 3, the option unit 50 is connected to the main system unit 20 by engaging the engagement ribs 38 of the main system unit 20 with the engagement grooves 66 of the second housing 52, and bringing the second connection side surface 52c of the second housing 52 and the first connection side surface 22c of the first housing 22 into contact with each other. As a result, the main system unit 20 and the option unit 50 form the device body 12 having a flat and rectangular shape.

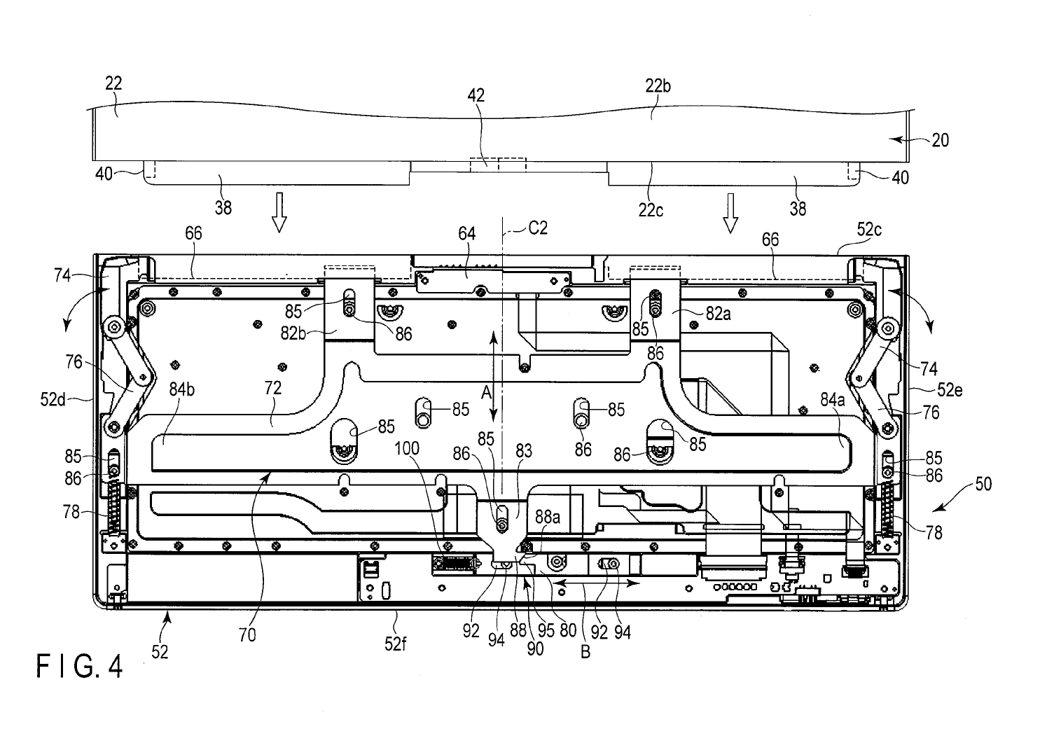

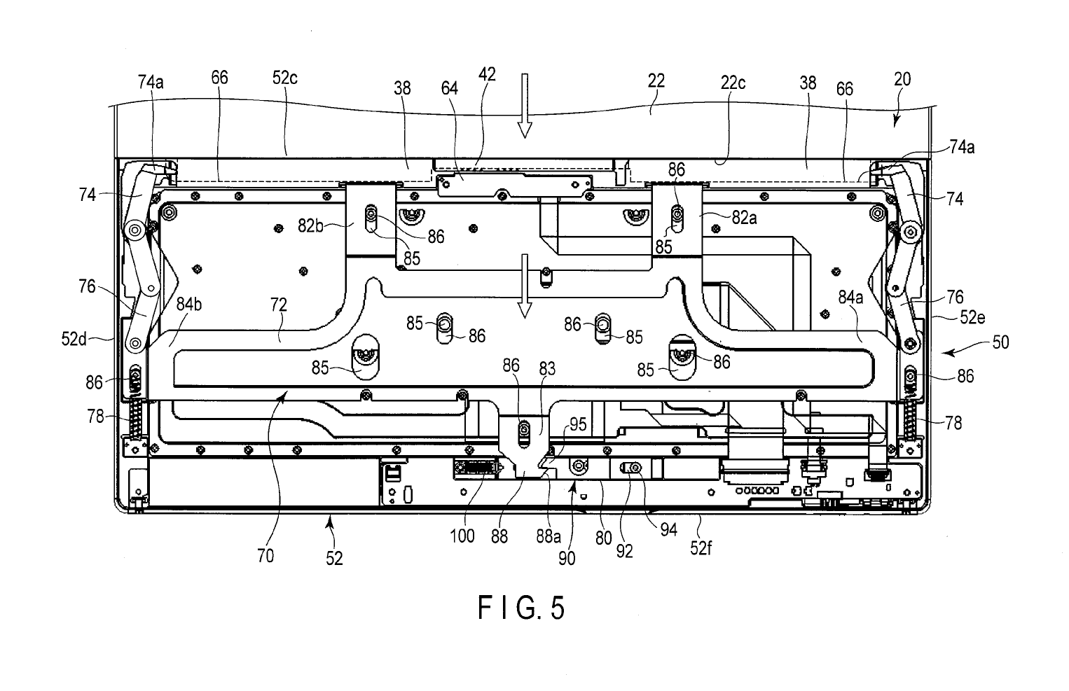

FIG. 4 is a plan view of an internal structure of the option unit 50 in the case where the option unit 50 is in a detached state, which is obtained as viewed from a lower side surface of the option unit. FIG. 5 is a plan view of the internal structure of the option unit 50 in the case where the option unit 50 is connected to the main system unit 20, which is obtained as viewed from the lower side surface of the option unit.

As shown in FIGS. 4 and 5, the option unit 50 comprises the lock mechanism 70, which is configured to lock the first housing 22 and second housing 52, with the first housing 22 and second housing 52 connected to each other, and a release lever 90 for use in releasing those housings from the above locked state, and the lock mechanism 70 and the release lever 90 are provided in the second housing 52. The lock mechanism 70 comprises a plate-like slider bracket 72, a pair of clamp hooks 74, a pair of linkage rods 76, a pair of slider springs (first urging members) 78 and a release latch 80, the slider bracket 72 being linearly movable in a reciprocative manner along a direction A perpendicular to the second connection side surface 52c of the second housing 52, the linkage rods 76 being configured to rotate the clamp hooks 74 in interlock with movement of the slider bracket 72, the slider springs 78 being configured to urge the slider bracket 72 toward a lock release position, the release latch 80 being configured to hold the slider bracket 72 in a lock position.

As a slide member, for example, the slider bracket 72, which is formed of a metal plate, comprises a pair of press arm portions (press portions) 82a and 82b, a pair of supporting arm portions 84a and 84b, and a single latch arm portion 83, which are provided as a single body. The slider bracket 72 includes a plurality of long holes 85 formed therein. The long holes 85 extend in a direction substantially perpendicular to the second connection side surface 52c of the second housing 52, and are formed to have a length corresponding to a stroke of movement of the slider bracket 72, i.e., a length of each of projections of the engagement ribs 38 of the first housing 22. At an inner surface (bottom surface) of the second housing 52, a plurality of guide pins 86 are provided upright. The slider bracket 72 is provided on the inner surface of the second housing 52, with the guide pins 86 inserted through the long holes 85. By virtue of this feature, the slider bracket 72 can be guided by the guide pins 86, and be moved in a reciprocating manner of predetermined strokes between the lock release position as shown in FIG. 4 and the lock position as shown in FIG. 5 in the direction A substantially perpendicular to the second connection side surface 52c of the second housing 52.

A pair of press arm portions 82a and 82b extend in the direction substantially perpendicular to the second connection side surface 52c of the second housing 52, and their distal end portions project into the pair of the engagement grooves 66. To be more specific, as shown in FIG. 5, the press arm portions 82a and 82b project into the engagement grooves 66 by a length corresponding to the predetermined stroke, with the slider bracket 72 moved to the lock release position. Thus, the distal end portions of the press arm portions 82a and 82b are brought into contact with the engagement ribs 38 of the first housing 52, which are to be engaged with the engagement grooves 66, and pushed toward an inside of the second housing 52.

The pair of supporting arm portions 84a and 84b extend in substantially parallel with the second connection side surface 52c to respective positions close to the both side surfaces 52e and 52d. The slider springs 78, which are formed of compression springs, are bridged between the second housing 52 and the distal end portions of the supporting arm portions 84a and 84b. The slider bracket 72 is urged by the slider springs 78 toward the lock release position, i.e., toward the second connection side surface 52c. Thereby, the slider bracket 72 is held in the lock release position by the slider springs 78, with the option unit 50 detached from the main system unit 20. Also, the slider springs 78 can prevent fluttering of the slider bracket 72 against an external force, and hold it in the lock release position.

In the second housing 52, the pair of clamp hooks 74 are provided close to the both side surfaces 52e and 52d, respectively, and also close to the second connection side surface 52c. The clamp hooks 74 are formed in the shape of pivot arms, and their center portions are supported by the second housing 52 such that the clamp hooks 74 are rotatable. Also, engagement claws (hooks) 74a are provided at one end portions of the clamp hooks 74. When the clamp hooks 74 are rotated from their release positions as shown in FIG. 4 to the their lock positions as shown in FIG. 5, the engagement claws 74a are projected into the engagement grooves 66 and engaged with, i.e., hooked on, the engagement concave portions 40 of the engagement ribs 38. Furthermore, the other end portions of the clamp hooks 74 are connected to the supporting arm portions 84a and 84b of the slider bracket 72 by the linkage rods 76. Both end portions of the linkage rods 76 are rotatably supported by the clamp hooks 74 and the supporting arm portions 84a and 84b, respectively. By virtue of this structure, the pair of clamp hooks 74 are rotated between the lock positions and the release positions in interlock with movement of the slider bracket 72.

It should be noted that the pair of press arm portions 82a and 82b and the pair of supporting arm portions 84a and 84b of the slider bracket 72 are formed symmetrically with respect to the center line C2 extending in the width direction of the second housing 52. Also, the pair of clamp hooks 74 are arranged symmetrically with respect to the center line C2.

The latch arm portion 83 of the slider bracket 72 extends from a substantially central portion of the slider bracket 72 which is substantially center in the longitudinal direction thereof, toward the front-end side surface 52f of the second housing 52. The latch arm portion 83 includes an engagement claw 88 at its distal end portion. A distal end surface of the engagement claw 88 forms an inclined surface 88a which inclines to the moving direction A of the slider bracket 72.

As shown in FIGS. 4, 5, and 6, the release latch 80 is formed elongate and rectangular. The release latch 80 is located on the inner surface of the second housing 52 and close to the front-end side surface 52f, and extend in substantially parallel to the front-end side surface 52f. The release latch 80 includes a plurality of long holes 92 extending in its longitudinal direction. Furthermore, on the inner surface of the upper surface of the second housing 52, a plurality of guide pins 94 are provided upright. The release latch 80 is provided, with the guide pins 94 inserted through the long holes 92. Thereby, the release latch 80 is provided on the inner surface of the second housing 52 to be movable in the direction B, which is perpendicular to the moving direction A of the slider bracket 72.

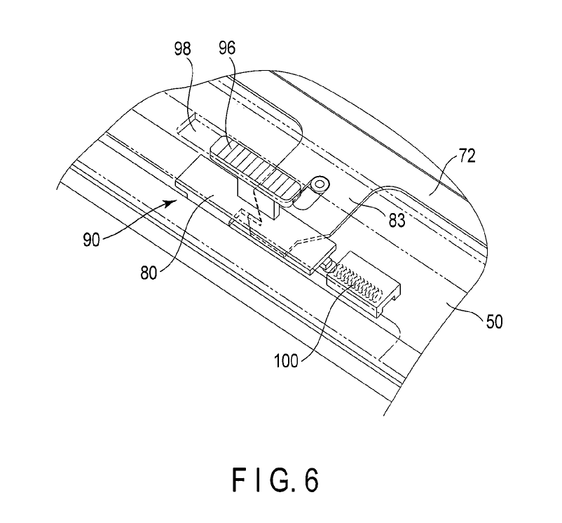

The release latch 80 includes a latch claw 95 and a release knob 96 formed integral with each other, the latch claw 95 being formed to project downwardly, the release knob 96 being formed to project upwardly. The latch claw 95 is also formed such that it can latch the engagement claw 88 of the slider bracket 72. In addition, the latch claw 95 includes an inclined surface 95a which can contact the inclined surface 88a of the engagement claw 88. As shown in FIG. 6, the release knob 96 is provided in a guide groove 98 formed in the upper surface 52a of the second housing 52, and supported such that it can perform a slide operation (release operation) from the outside of the second housing 52. In such a manner, the release latch 80 including the release knob 96 forms the release lever 90, which serves as a release member.

As shown in FIGS. 4 to 6, a release spring 100 formed of a pull spring is bridged as a second urging member between one end of the release latch 80 and the second housing 52. The release latch 80 is urged by the release spring 100 in a direction where the latch claw 95 is engaged with the engagement claw 88 of the slider bracket 72, i.e., a latch direction.

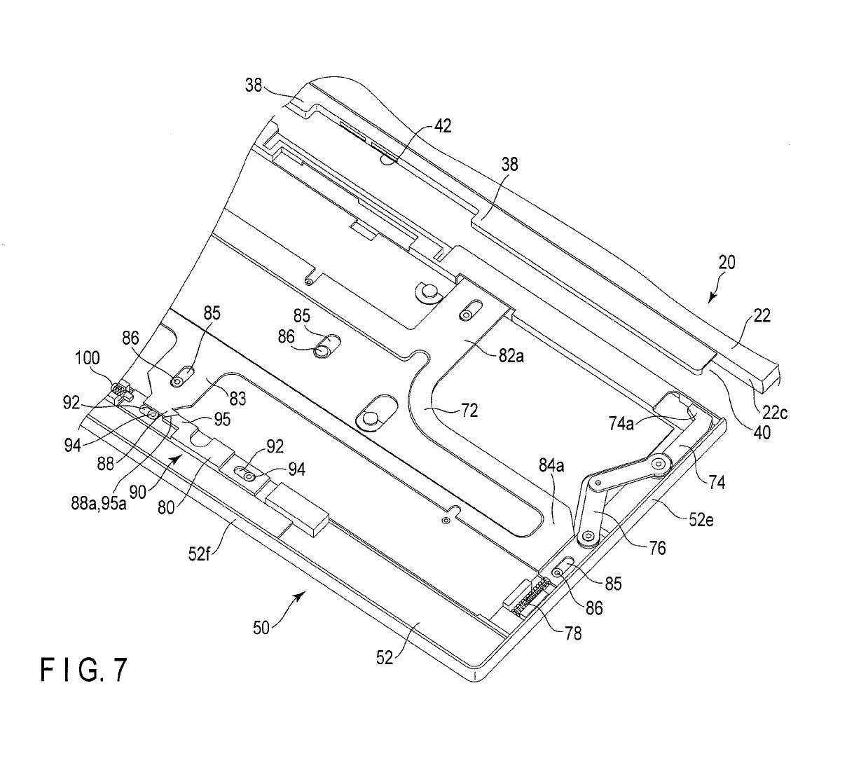

Due to the lock mechanism 70 and the release latch 80 (the release lever 90) having the above structure, as shown in FIGS. 4 and 7, the slider bracket 72 is urged by the slider springs 78, and held in the lock release position by the slider springs 78, with the option unit 50 detached from the main system unit 20. Thereby, the pair of press arm portions 82a and 82b project into the engagement grooves 66. Also, the pair of clamp hooks 74 are rotated to their release positions, and the engagement claws 74a are held in respective positions where they are detached from the engagement grooves 66. In the release latch 80, the inclined surface 95a is brought into contact with the inclined surface 88a of the engagement claw 88, and held in its release position.

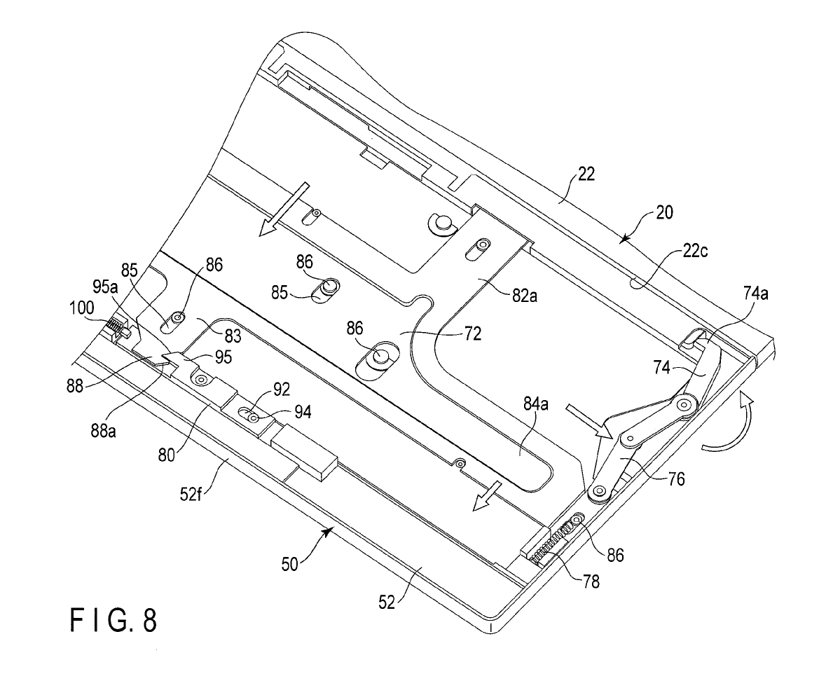

As shown in FIGS. 5 and 8, when the option unit 50 is connected to the main system unit 20, that is, when the engagement ribs 38 of the first housing 22 are pushed until they contact bottom portions of the engagement grooves 66 of the second housing 52, and engaged with the engagement grooves 66, and the first connection side surface 22c of the first housing 22 and the second connection side surface 52c of the second housing 52 are made to face each other to come into contact with each other, thereby connecting the second housing 52 to the first housing 22, the pair of press arm portions 82a and 82b are pushed by the engagement ribs 38, and the slider bracket 72 is moved from the lock release position to the lock position. In interlock with this movement of the slider bracket 72, the pair of the clamp hooks 74 are rotated from their release positions to their lock positions. The engagement claws 74a of the clamp hooks 74 are projected into the engagement grooves 66 of the second housing 52, and engaged with concave portions 40 of the engagement ribs; that is, they are caught by the concave portions 40. In such a manner, the pair of engagement ribs 38 are caught from left and right sides by the pair of clamp hooks 74, and locked while being engaged with the engagement grooves 66.

While the slider bracket 72 is being moved from the lock release position to the lock position, the engagement claw 88 of the latch arm position 83 is moved while pushing the inclined surface 95a of the release latch 80 with its inclined surface 88a, to move the release latch 80 to the release position once. Then, when the engagement claw 88 is pushed to the lock position, the latch claw 95 of the release latch 80 is detached from the engagement claw 88. Thereby, the release latch 80 is moved to the lock position by the release spring 100, and the latch claw 95 is caught by the engagement claw 88, thereby latching, i.e., locking the slider bracket 72 in the lock position.

Due to the above operation, the lock mechanism 70 locks the first housing 22 connected to the second housing 52, and prevents the second housing 52 from being accidentally detached from the first housing 22.

On the other hand, in the case of detaching the option unit 50 from the main system unit 20, the release knob 96 is slid in its release direction to move the release latch 80 from the lock position to the release position. Thereby, the latch claw 95 is separated from the engagement claw 88 of the slider bracket 72, thus releasing the slider bracket 72 from the locked state. As a result, the slider bracket 72 is pushed out by the slider springs 78 from the lock position to the lock release position. In interlock with movement of the slider bracket 72, the pair of clamp hooks 74 are rotated from the lock positions to the release positions. Thereby, the engagement claws 74a of the clamp hooks 74 are detached from the concave portions 40 of the engagement ribs 38, and thus those members are released from their locked states. Furthermore, after this lock release operation, the press arm portions 82a and 82b of the slider bracket 72 are moved to the lock release position thereof while pushing the engagement ribs 38 in a direction where they will be separated from the engagement grooves 66. In such a manner, the option unit 50 can be detached from the main system unit 20 by releasing the lock above members from the locked state, and pulling out the engagement ribs 38 from the engagement grooves 66.

In the portable computer 10 having the above structure, the device body 12 comprises the main system unit 20 and the option unit 50 detachably connected to the main system unit 20. That is, the main system unit and the option unit form the device body 12 having a flat and rectangular shape.

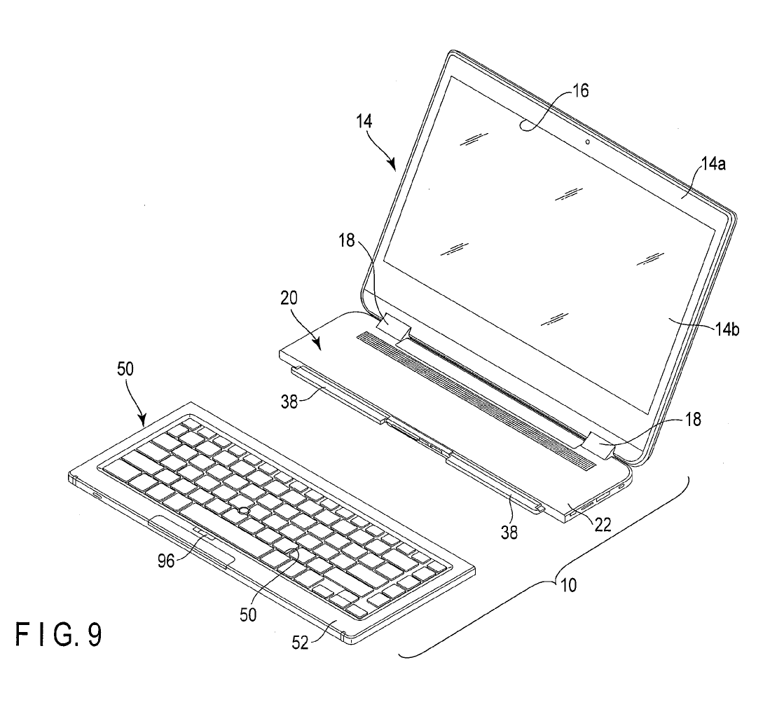

The portable computer 10 can be used, with the main system unit 20 and the option unit (keyboard unit) 50 connected to each other as shown in FIG. 1, and can also be used, with the option unit 50 detached from the main system unit 20 as shown in FIG. 9. In the case where the portable computer 10 is used, with the option unit 50 detached from the main system unit 20, a key input signal of the keyboard 56 is sent from the option unit 50 to the main system unit 20 with wireless communication.

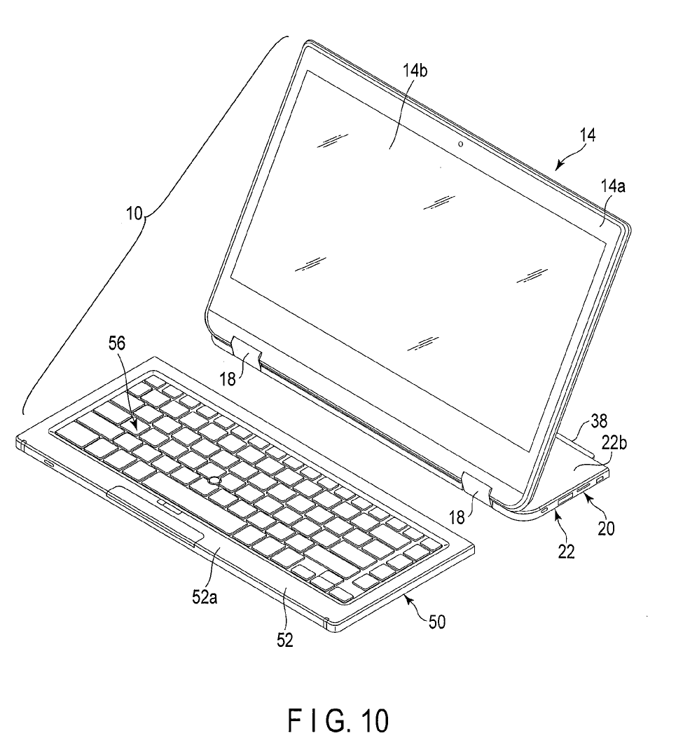

Also, the portable computer 10 can be used, with the option unit 50 detached from the main system unit 20, and in addition the main system unit 20 reversed as shown in FIG. 10.

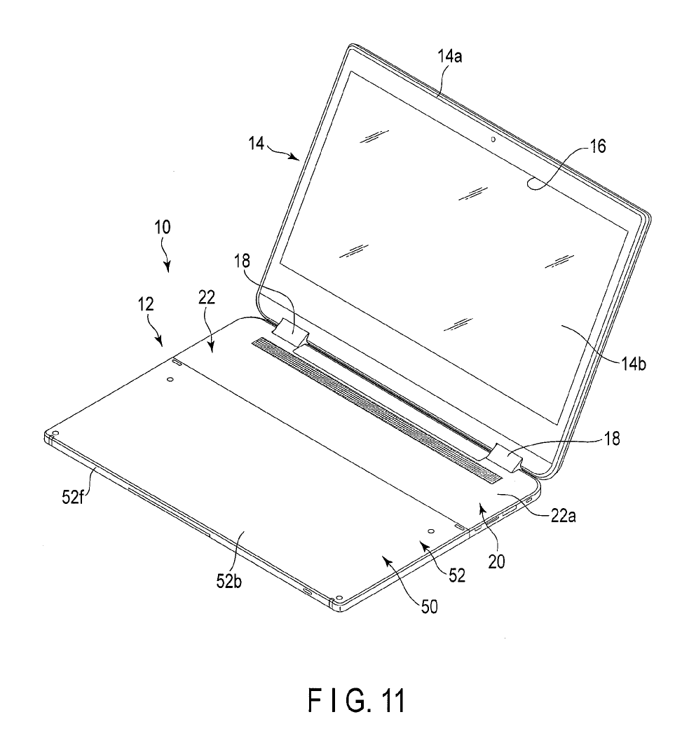

Furthermore, the engagement ribs 38 of the main system unit 20 are formed symmetrically with respect to the center line of the first housing 22, the clamp hooks of the lock mechanism 70, the engagement grooves 66 of the option unit 50, the clamp hooks of the lock mechanism 70, etc. are formed symmetrically with respect to the center line of the second housing 52. Thus, as shown in FIG. 11, the option unit 50 can be connected to the main system unit 20, with the upper surface 52a and the lower surface 52b reversed. Therefore, the portable computer 10 can be used, with the option unit 50 reversed.

As described above, since the option unit 50, which forms part of the device body, can be detached, the portable computer 10 can be used in various manners.

Furthermore, in the portable computer 10, the option unit 50 can be connected to the main system unit 20 by a simple operation in which the engagement ribs of the first housing are pushed into the engagement grooves of the second housing, and further in interlock with the above pushing operation, the option unit 50 can be locked in the above connected state by the lock mechanism. The lock mechanism includes the pair of clamp hooks provided at the both edge portions of the second housing in the longitudinal direction thereof, and can reliably and stably lock the first housing by catching the engagement ribs of the first housing from the both edge sides with the clamp hooks.

The release lever is slidably formed. When being slid, the release lever releases the first housing from locking of the lock mechanism. There is a low possibility that the release lever may perform its release operation by mistake, as compared with a push type of release button. Also, the release lever can prevent from the lock releasing operation from being performed accidentally.

By virtue of the above structure, according to the embodiment, it is possible to provide an electronic device which can be used in various manners, and also enables the option unit to be easily and reliably connected and disconnected to and from the system unit.

Next, portable computers according to other embodiments will be explained. With respect to the other embodiments, elements identical to those in the first embodiment will be denoted by the same reference numerals as in the first embodiment, and their detailed explanations will be omitted.

In the electronic device, the option unit is not limited to the above keyboard unit; that is, various option units having other functions can be each used as the above option unit.

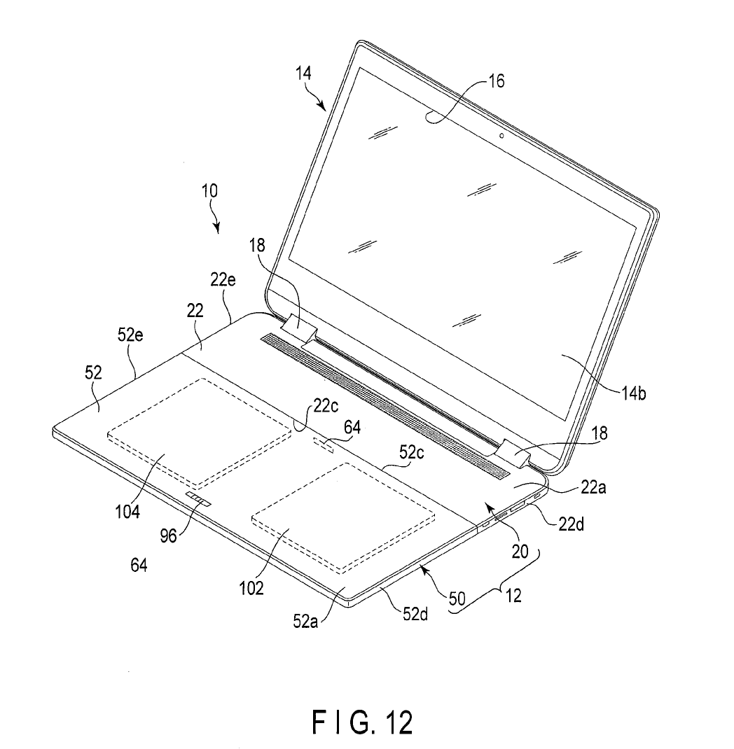

FIG. 12 is a perspective view of a portable computer according to a second embodiment. In the second embodiment, an option unit 50 which forms part of a device body 12 is made as a battery unit. To be more specific, the option unit 50 comprises a flat and rectangular second housing 52, a single or a plurality of batteries 102 and 104 provided as option devices in the second housing 52, a lock mechanism provided in the second housing 52, and a release lever (a release latch and a release knob 96).

The second housing 52 has the same size and the same structure as the second housing in the first embodiment; however, an upper surface 52a of the second housing 52 has no opening, that is, a substantially entire part of the upper surface 52a is closed. Also, the lock mechanism and the release lever have the same sizes and the same structures as the lock mechanism and release lever (the release latch and the release knob) in the first embodiment. The batteries 102 and 104 are connected to a power supply connector 64 of the option unit 50, and then connected to a main system unit 20 by the power supply connector 64 and a power supply connector of the main system unit 20.

The other structural features of the portable computer 10 are the same as those of the portable computer according to the first embodiment.

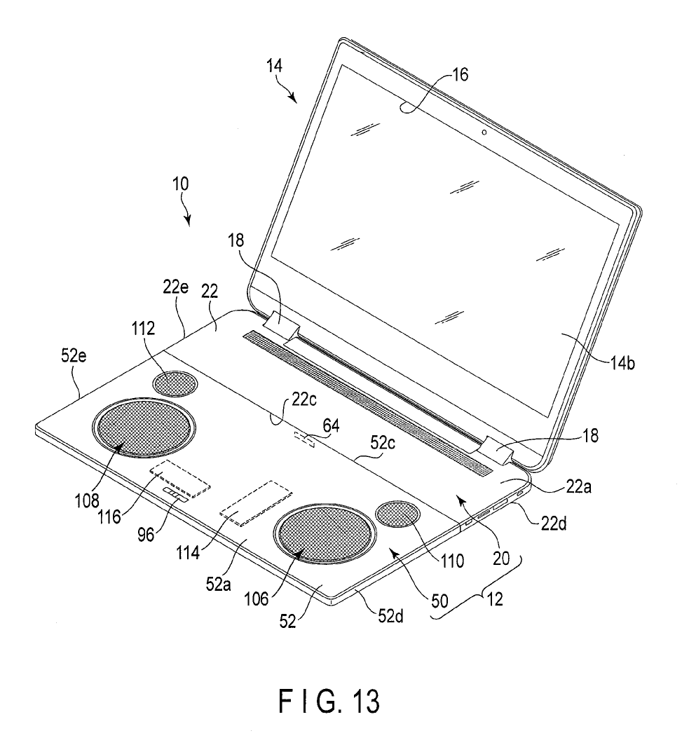

FIG. 13 is a perspective view of a portable computer according to a third embodiment. In the third embodiment, an option unit 50 which forms part of a device body 12 is made as a speaker unit. To be more specific, the option unit 50 comprises a flat and rectangular second housing 52, a single or a plurality of speakers 106, 108, 110 and 112 provided as option devices in the second housing 52, a lock mechanism provided in the second housing 52, and a release lever (a release latch and a release knob 96).

The second housing 52 has the same size and the same structure as the second housing in the first embodiment. In an upper surface 52a of the second housing 52, a plurality of openings are formed. The speakers 106, 108, 110 and 112 are located opposite to the openings, respectively. In the second housing 52, a battery 114 for driving the speakers 106, 108, 110 and 112 and a communication module 116 configured to supply an audio signal to the speakers 106, 108, 110 and 112 after receiving the audio signal sent from the main system unit 20. The battery 114 is connected to a power supply connector 64 of the option unit 50, and then connected to the main system unit 20 by the power supply connector 64 and a power supply connector of the main system unit 20.

The lock mechanism and the release lever have the same sizes and the same structures as the lock mechanism and the release lever (the release latch and the release knob) in the first embodiment.

The other structural features of the portable computer 10 are the same as those of the portable computer according to the first embodiment.

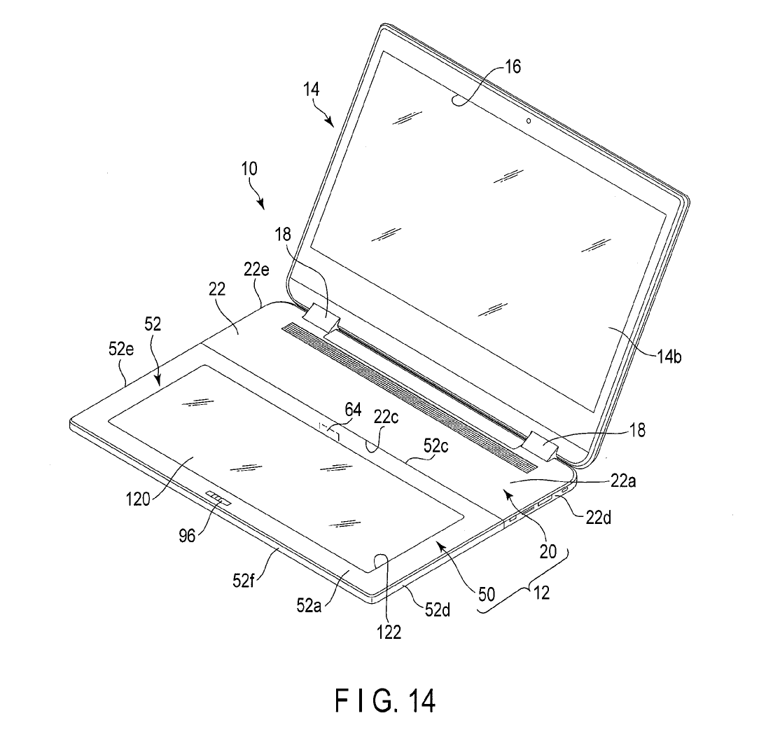

FIG. 14 is a perspective view of a portable computer according to a fourth embodiment. According to the fourth embodiment, an option unit 50 which forms part of a device body 12 is made as a second display unit. To be more specific, the option unit 50 comprises a flat and rectangular second housing 52, a display panel 120 provided as an option device in the second housing 52, a lock mechanism provided in the second housing 52, and a release lever (a release latch and a release knob 96).

The second housing 52 has the same size and the structure as the second housing in the first embodiment. In the upper surface 52a of the second housing 52, a rectangular opening 122 is formed. The display panel 120 is provided in the second housing 52, with its display surface exposed at the opening 122. The display panel 120 includes, e.g., a liquid crystal display panel and a touch panel. Furthermore, in the second housing 52, a communication board (Bluetooth module), a battery, etc. are provided, the communication board being configured to wirelessly send an input signal and an image data signal to the display panel 120, the battery being provided to supply power to the display panel 120. The battery is connected to a power supply connector 64 of the option unit 50, and then connected to a man system unit 20 by the power supply connector 64 and a power supply connector of the main system unit 20.

The lock mechanism and the release lever have the same sizes and the same structure as the lock mechanism and the release lever (the release latch and the release knob) in the first embodiment.

The other structural features of the portable computer 10 are the same as those of the portable computer according to the first embodiment.

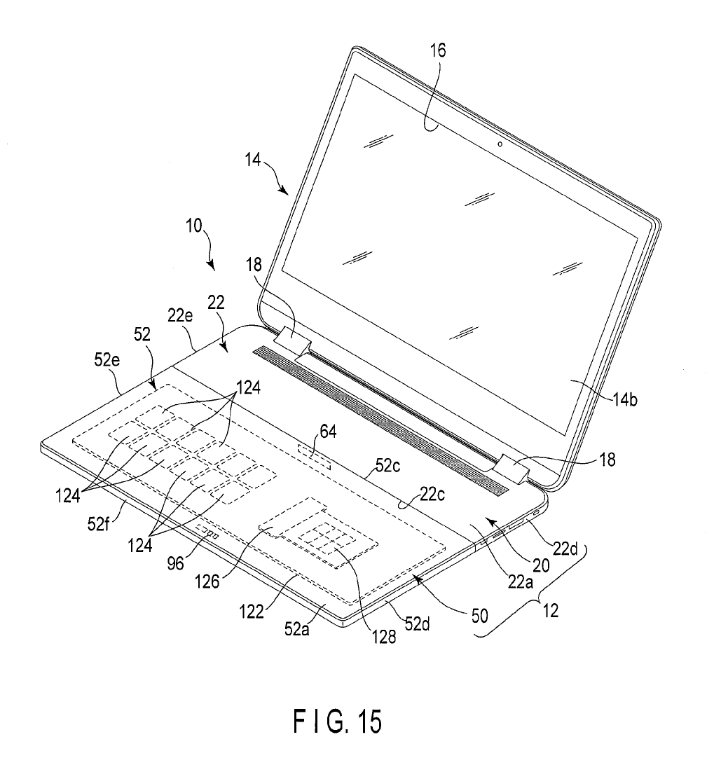

FIG. 15 is a perspective view of a portable computer according to a fifth embodiment. According to the fifth embodiment, the option unit 50 is formed as a storage unit having a large capacity. To be more specific, the option unit 50 comprises a flat and rectangular second housing 52, a plurality of storage devices provided as option devices in the second housing 52, a lock mechanism provided in the second housing 52, and a release lever (a release latch and a release knob 96). In the second housing 52, a print circuit board 122 is provided, and on the print circuit board, a plurality of flash memories 124 are mounted as storage devices. Also, on the circuit board 122, a connector 126 is mounted, and to the connector 126, a solid-state drive (SSD) 128 is connected. However, the storage devices are not limited to a combination of the flash memories 124 and the SSD 128. That is, either the flash memories 124 or the SSD 128 may be provided.

The second housing 52 has the same size and the same structure as those of the second housing in the first embodiment. However, the upper surface 52a of the second housing 52 is closed without having an opening. The lock mechanism and the release lever have the same sizes and the same structures as the lock mechanism and the release lever (the release latch and the release lever) in the first embodiment.

The other structural features of the portable computer 10 are the same as those of the portable computer according to the first embodiment.

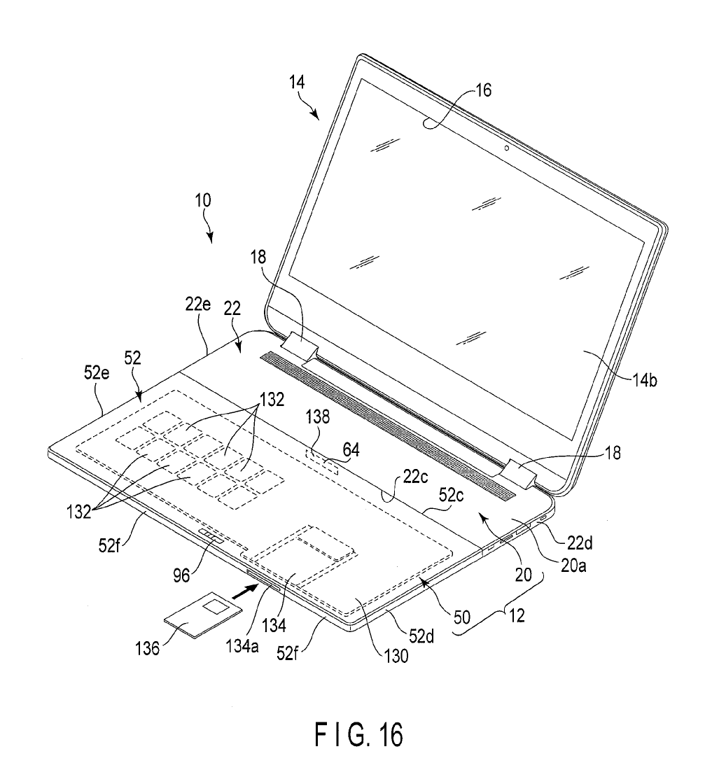

FIG. 16 is a perspective view of a portable computer according to a sixth embodiment. According to the sixth embodiment, as an option unit 50, a television (TV) unit is provided which can perform video recording. To be more specific, the option unit 50 comprises a second housing 52, a TV board 130 provided as an option device in the second housing 52, a lock mechanism provided in the second housing 52, and a release lever (a release latch and a release knob 96).

The TV board 130 comprises a print circuit board (PCB), a plurality of memories (flash memories) 132 mounted on the PCB, a card slot 134 provided on the PCB, and a smart card (terrestrial digital card) which can be loaded into the card slot through a slit 134a. The TV board 130 is connected to a main system unit 20 by an antenna connector 138 and a power supply connector 64.

The second housing 52 has the same size and the same structure as the second housing in the first embodiment. However, the upper surface 52a of the second housing 52 is closed without having an opening. The lock mechanism and the release lever have the same sizes and the same structures as the lock mechanism and release lever (the release latch and the release knob) in the first embodiment.

The other structural features of the portable computer 10 are the same as those of the portable computer according to the first embodiment.

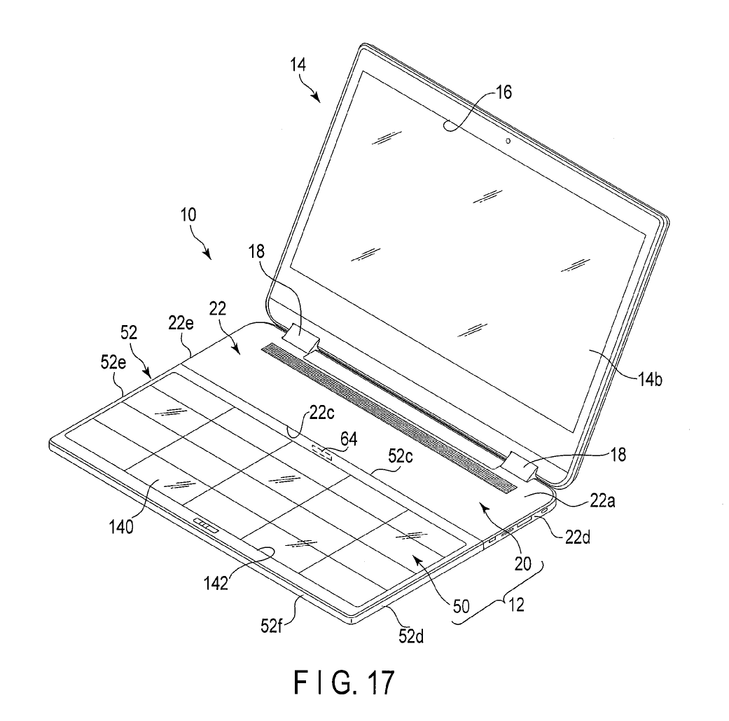

FIG. 17 is a perspective view of a portable computer according to a seventh embodiment. According to the seventh embodiment, an option unit 50 is formed as a solar panel unit. To be more specific, the option unit 50 comprises a flat and rectangular second housing 52, a solar panel 140 provided as an option device in the second housing 52, a lock mechanism provided in the second housing 52, and a release lever (a release latch and a release knob 96).

The second housing 52 has the same size and the same structure as the second housing in the first embodiment. In an upper surface 52a of the second housing 52, a rectangular opening 142 is formed. The solar panel 140 is provided in the second housing 52, with its light-receiving surface exposed at an opening 142. The solar panel 140 is connected to the main system unit 20 by a power supply connector 64, and can supply generated power to the main system unit 20.

The lock mechanism and the release lever have the same sizes and the same structured as the lock mechanism and release lever (the release latch and the release knob) in the first embodiment.

The other structural features of the portable computer 10 are the same as those of the portable computer according to the first embodiment.

The portable computers according to the second to seventh embodiments which have the above structures can also the same advantages as the portable computer according to the first embodiment. Furthermore, it is possible to replace an arbitrary one of the option units 50 described with respect to the first to seventh embodiments with another arbitrary one of the option units 50, and connect the other arbitrary option unit 50 to the main system unit 50. Therefore, the usage patterns of the portable computer can be further increased.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, each of the engagement ribs (the first engagement portions) of the first housing is not limited to a continuous stretch of long rib; that is, a plurality of divided short ribs may be provided in place of the continuous stretch of long rib. The connection structure for connecting the main system unit and the option unit is not limited to a combination of the engagement ribs (the first engagement portions) and the engagement grooves (the second engagement portions); that is, another connection structure may be applied. The shape of each of the first and second housings is not limited to a rectangular shape; that is, each housing may be formed in another shape.

The electronic device is not limited to the portable computer; that is, various kinds of electronic devices such as a portable terminal, a portable telephone and a tablet computer may be applied.

What is claimed is:

1. An electronic device comprising:
a device body comprising a main system unit and an option unit detachably connected to the main system unit,
wherein the main system unit comprises:
a first housing including a first main surface, a second main surface opposing to the first mine surface, a first connection side surface, and a first engagement portion provided at the first connection side surface, and
a main control circuit board in the first housing, and
wherein the option unit comprises:
a second housing including a first main surface continuous with the first main surface of the first housing, a second main surface continuous with the second main surface of the first housing, a second connection side surface configured to oppose to the first connection side surface of the first housing, and the second engagement portion provided at the second connection side surface and configured to detachably engage with the first engagement portion;
an option device in the second housing;
a lock mechanism provided at the second housing, and configured to lock the second housing, with the second housing connected to the first housing; and
a release member configured to release from locking of the lock mechanism.

2. The electronic device of claim 1, wherein the lock mechanism comprises a slide member comprising a press portion configured to abut the first engagement portion of the first housing, and provided in the second housing to be movable between a lock release position and a lock position; a clamp hook provided in the second housing to be movable in a lock position where the clamp hook is engaged with the first engagement portion and a release position where the clamp hook is detached from the first engagement portion, the clamp hook being connected to the slide member and being movable in interlock with movement of the slide member; and an urging member configured to urge the slide member toward the lock release position.

3. The electronic device of claim 2, wherein the lock mechanism comprises a slider latch provided in the second housing to be movable between a lock position where the slider latch is engaged with the slide member to lock the slide member in the lock position therefor and a release position where the slider latch is detached from the slider member to release the slider member from a locked state thereof; and a second urging member configured to urge the slider latch toward the lock position therefor.

4. The electronic device of claim 3, wherein the release member comprises a release knob connected to the slider latch, exposed at the first mane surface of the second housing, and slidably supported.

5. The electronic device of claim 4, wherein the first engagement portion includes an engagement rib projecting from the first connection side surface and extending in a longitudinal direction of the first connection side surface, and the second engagement portion includes an engagement groove which is formed in the second connection side surface, and with which the engagement rib is engaged.

6. The electronic device of claim 1, wherein the second housing includes an opening formed in the first main surface, and the option device includes a keyboard provided in the second housing and opposite to the opening.

7. The electronic device of claim 1, wherein the option device includes a battery provided in the second housing.

8. The electronic device of claim 1, wherein the option device comprises a speaker provided in the second housing, and the second housing includes an opening formed in the first main surface and opposite to the speaker.

9. The electronic device of claim 1, wherein the second housing comprises an opening formed in the first main surface, and the option device includes a display panel provided in the second housing and opposite to the opening.

10. The electronic device of claim 1, wherein the option device comprises a circuit board provided in the second housing and a storage device on the circuit board.

11. The electronic device of claim 1, wherein the second housing comprises an opening formed in the first main surface, and the option device includes a solar panel provided in the second housing and opposite to the opening.

12. The electronic device of claim 1, wherein the option device comprises a TV board provided in the second housing, a memory mounted on the TV board, and an IC card connectable to the TV board.
